(19) United States
(12) Patent Application Publication
(10) Pub. No.: US 2026/0029948 A1
(43) Pub. Date: Jan. 29, 2026

(54) HOST CONFIGURED PERFORMANCE LIMITS

(71) Applicant: Micron Technology, Inc., Boise, ID (US)

(72) Inventor: David Aaron PALMER, Boise, ID (US)

(21) Appl. No.: 19/219,053

(22) Filed: May 27, 2025

Related U.S. Application Data
(60) Provisional application No. 63/675,154, filed on Jul. 24, 2024.

(51) Int. Cl. G06F 3/06

(52) U.S. Cl. CPC G06F 3/0655; G06F 3/0604; G06F 3/0679

(57) ABSTRACT

In some implementations, a memory apparatus may transmit, to a host system, capability information indicating one or more supported memory operations of the memory apparatus. The memory apparatus may receive, from the host system, configuration information indicating one or more performance limits for at least one supported memory operation of the one or more supported memory operations.

### CROSS-REFERENCE TO RELATED APPLICATION

This patent application claims priority to U.S. Provisional Patent Application No. 63/675,154, filed on Jul. 24, 2024, entitled “HOST CONFIGURED PERFORMANCE LIMITS,” and assigned to the assignee hereof. The disclosure of the prior application is considered part of and is incorporated by reference into this patent application.

### TECHNICAL FIELD

The present disclosure generally relates to memory devices, memory device operations, and, for example, to host configured performance limits.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source.

### BRIEF DESCRIPTION OF THE DRAWINGS

FIG. 1 is a diagram illustrating an example system capable of host configured current limits.

FIGS. 2A and 2B are diagrams of an example of host configured performance limits.

FIG. 3 is a diagram of an example of host configured performance limits.

FIG. 4 is a flowchart of an example method associated with host configured performance limits.

FIG. 5 is a flowchart of an example method associated with host configured performance limits.

### DETAILED DESCRIPTION

Electronic device manufactures, such as manufactures of mobile devices, smartphones, laptops, tablets, and/or vehicles, among other examples, may obtain computing components, such as a memory apparatus, for a line of electronic devices from multiple sources. For example, to manufacture a product line of electronic devices, a manufacturer may obtain memory apparatuses from various memory apparatus manufacturers. Accordingly, different electronic devices within a product line may include memory apparatuses from different manufactures. Although the various memory apparatuses may satisfy minimum performance specifications for the product line, variations between in the techniques and/or technologies used by the different memory apparatus manufacturers may lead to different performance capabilities between memory apparatuses. For example, different memory apparatus manufacturers may produce memory apparatuses having different performance characteristics, such as data transfer rates, operations speed, latency, and/or other quality of service (QoS) parameters, among other examples. Further, manufacturing variations may result in performance variations in memory apparatuses made by a single manufacturer.

Accordingly, the performance of electronic devices of a product line may vary. For example, performance of electronic devices in a product line, such as data transfer rates associated with read and write speeds, current consumption, battery life, and/or memory apparatus reliability, among other examples may be different depending on the individual characteristics of the memory apparatus used for a particular electronic device. Such variations in performance may result in non-uniform or negative user experience, and/or unpredictable or inaccurate specifications of electronic device performance, among other examples. As another example, the non-uniform performance across electronic devices (e.g., due to non-uniform data transfer rates of memory apparatuses included in the electronic devices) may result in increased complexity associated with system management by a host system of an electronic device because the performance of a memory apparatus included in the electronic device may be difficult to predict or estimate by the host system. Further, the memory apparatus may perform one or more operations at a higher or better performance than is needed to meet one or more performance criteria for the one or more operations (e.g., operating at or near a maximum capability of the memory apparatus), thereby increasing stress on components of the memory apparatus, increasing the likelihood of overheating by the memory apparatus, and/or increase the likelihood of damage or failure for one or more components of the memory apparatus, among other examples.

Some implementations described herein enable host configured performance limits for a memory apparatus. For example, a host system may standardize performance for a memory apparatus, in accordance with performance capabilities of the memory apparatus by setting one or more performance limits for the memory apparatus. For example, a host system may transmit, and the memory apparatus may receive, a request for supported memory operations of the memory apparatus. As used herein, a supported memory operation of a memory apparatus may include a type of memory operation, such as one or more types of read operations and/or one or more types of write operations. For example, a supported memory operation may include a sequential read operation, a sequential write operation, a random read operation, and/or a random write operation, among other examples. A supported memory operation may be referred to as a “supported use case” interchangeably herein.

Based on receiving the request, the memory apparatus may transmit, and the host system may receive, capability information associated with the supported memory operations. The capability information may include one or more information elements, such as fields of a device descriptor associated with the memory apparatus, that indicate memory operations supported by the memory apparatus. In some examples, the capability information may include an indication of a data transfer rate or other performance metric associated with the supported memory operations. For example, the capability information may include an indication of a data transfer rate for a sequential read operation, a data transfer rate for a sequential write operation, a data transfer rate for a random read operation, and/or a data transfer rate for a random write operation.

In some implementations, a memory apparatus may support multiple performance modes. For example, the memory apparatus may support a mode that enables write-booster operations, in which the memory apparatus performs write operations from the host system to by storing data from the host system to single level cells (SLCs), rather than storing the data to memory cells configured to store multiple bits of data, such as multi-level cells (MLCs), triple-level cells (TLCs), and/or quad-level cells (QLCs), among other examples. Accordingly, the data transfer rate of write-booster operations may be different (e.g., higher) than the data transfer rate of non-write-booster operations (e.g., memory operations in which the memory apparatus may store data to SLCs, MLCs, TLCs, QLCs, or any combination thereof). In such implementations, the capability information may include an indication of whether the memory apparatus supports write-booster operations, and/or an indication of a data transfer rate associated with the write-booster operations.

Based on receiving the capability information, the host system may determine configuration information that indicates performance limits for respective supported memory operations of the memory apparatus. As described herein, a performance limit may indicate values of respective thresholds of one or more thresholds associated with performance parameters of the memory apparatus. For example, a performance limit may indicate a value of a threshold associated with a throughput parameter (e.g., an amount of data processed by the memory apparatus over a duration, such as a time window) for a memory operation. Additionally, or alternatively, a performance limit may indicate a value of a threshold associated with a latency parameter (e.g., a duration allotted to the memory apparatus) to process data associated with the memory operation. The host system may transmit, and the memory apparatus may receive, the configuration information.

Based on receiving the configuration information from the host system, the memory apparatus may perform subsequent memory operations in accordance with the configuration information. For example, the memory apparatus may define or modify one or more operational parameters, such as by adjusting the speed of memory operations and/or adjusting parameters associated with a credit scheme used to manage memory operations, among other examples, to operate in accordance with the performance limits.

As a result, by enabling the host system to configure a memory apparatus to operate in accordance with one or more performance limits, electronic devices of a product line may have improved uniformity of performance, regardless of individual performance variations of a memory apparatus across different manufacturers, and/or performance variations due to manufacturing variations. Additionally, by enabling the host system to define performance limits, a diversity of types of memory apparatuses that may be included in the electronic device may be improved. For example, if an electronic device supports a lower performance standard of memory apparatus (e.g., older models of a memory apparatus), then the electronic device may use a higher performance memory apparatus and may limit the performance of the memory apparatus by configuring the one or more performance limits (e.g., causing the memory apparatus to operate at a relatively lower performance). Further, by operating a memory apparatus at a relatively lower performance, an electronic device may extend the lifespan of a memory apparatus, reduce a likelihood of component failure for the memory device, and/or reduce the likelihood of overheating by the memory apparatus, among other examples. This may reduce electronic waste and improve reliability of the memory apparatus. Additionally, by enabling the memory apparatus to operate at a relatively lower performance, the memory apparatus may conserve power or energy that would have otherwise been associated with the operation of the memory apparatus at a performance level that is greater than a configured performance limit.

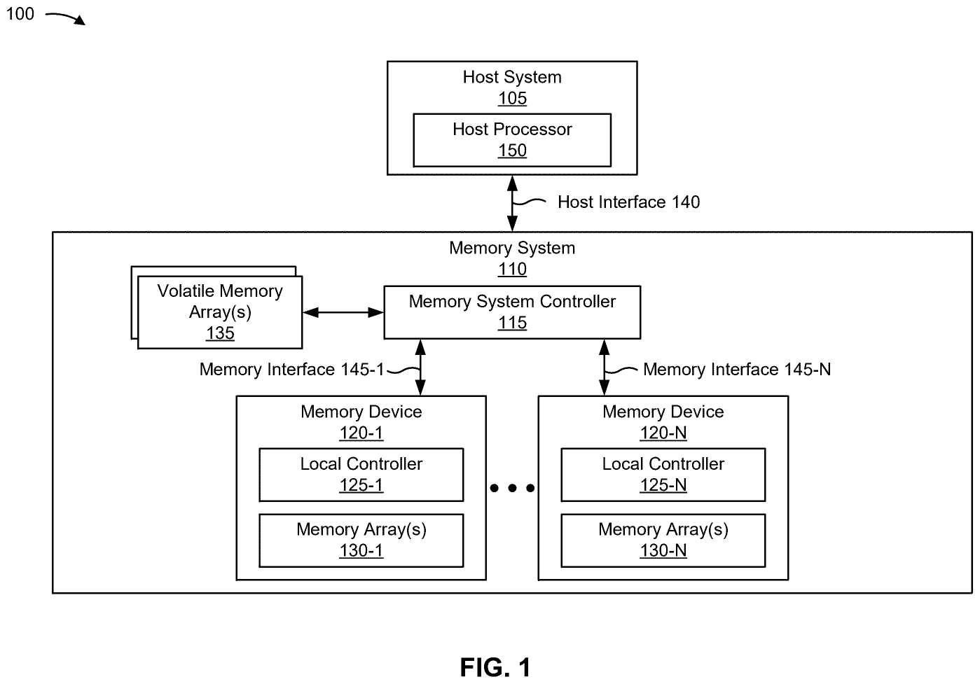

FIG. 1 is a diagram illustrating an example system 100 capable of host configured current limits. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, and/or a DIMM interface.

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some implementations, one or more systems, devices, apparatuses, components, and/or controllers of FIG. 1 may be configured to receive, from a host system, configuration information indicating one or more performance limits for respective memory operations of one or more memory operations; and perform the one or more memory operations in accordance with the one or more performance limits.

In some implementations, one or more systems, devices, apparatuses, components, and/or controllers of FIG. 1 may be configured to: transmit, to a memory apparatus, a request for supported memory operations of the memory apparatus; receive, from the memory apparatus, capability information indicating one or more supported memory operations; and transmit, to the memory apparatus, configuration information indicating one or more performance limits for at least one supported memory operation of the one or more supported memory operations.

In some implementations, one or more systems, devices, apparatuses, components, and/or controllers of FIG. 1 may be configured to transmit, to a host system, capability information indicating one or more supported memory operations of the memory apparatus; and receive, from the host system, configuration information indicating one or more performance limits for at least one supported memory operation of the one or more supported memory operations.

In some implementations, one or more systems, devices, apparatuses, components, and/or controllers of FIG. 1 may be configured to communicate, via the host interface and to the host system, capability information of the memory apparatus indicating one or more supported memory operations of the memory apparatus; and communicate, via the host interface and to the memory apparatus, configuration information indicating one or more performance limits for at least one supported memory operation of the one or more supported memory operations.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

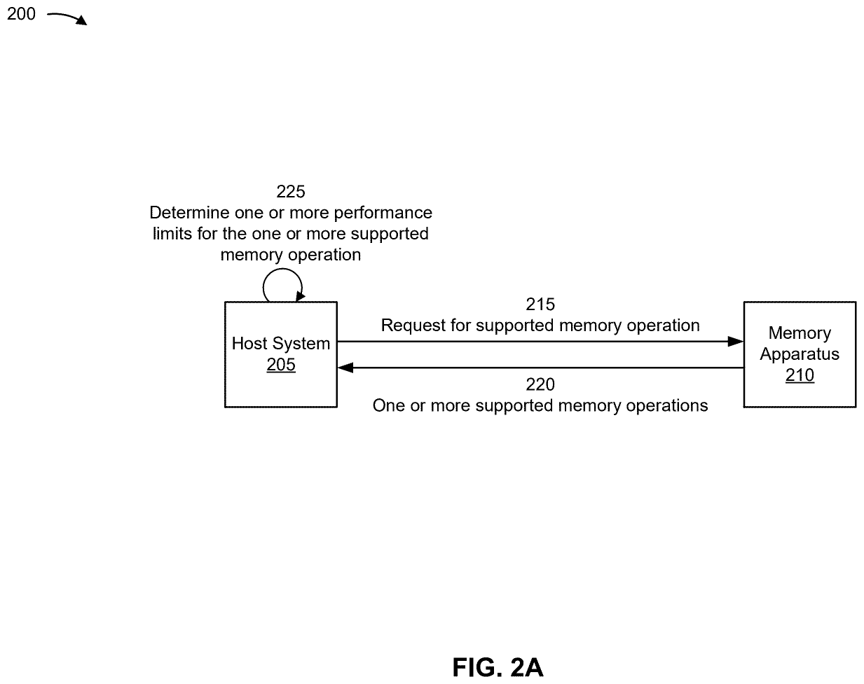

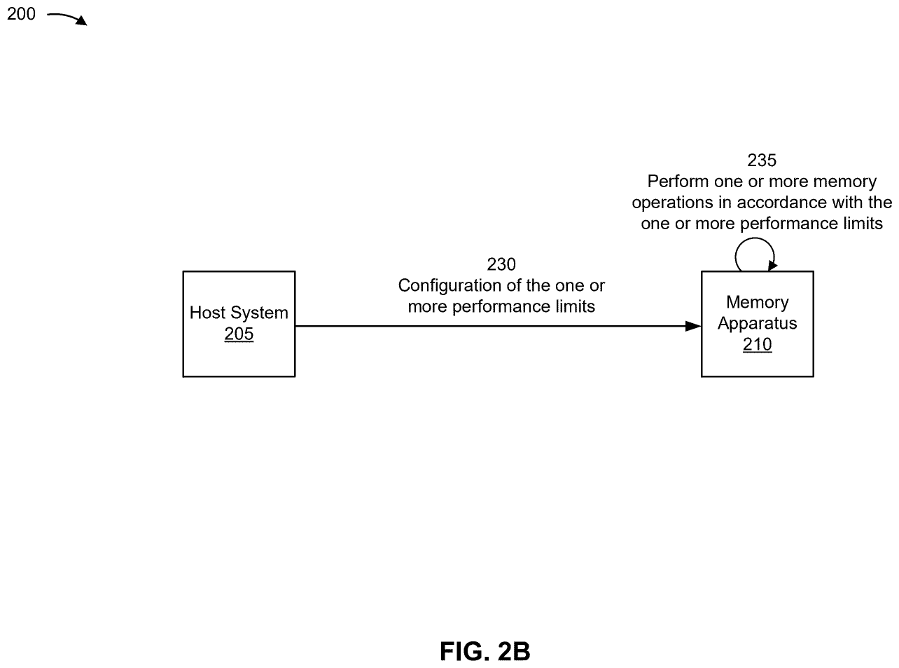

FIGS. 2A and 2B are diagrams of an example 200 of host configured performance limits. The operations described in connection with FIGS. 2A and 2B may be performed by the memory system 110 and/or one or more components of the memory system 110, such as the memory system controller 115, one or more memory devices 120, and/or one or more local controllers 125. Additionally, or alternatively, the operations described in connection with FIGS. 2A and 2B may be performed by the system 100, the host system 105, one or more components of the host system 105 (e.g., the host processor 150), and/or the host interface 140.

As shown in FIGS. 2A and 2B, the example 200 may include a host system 205 and a memory apparatus 210. The host system 205 may be the host system 105. The memory apparatus 210 may be, or may include, the memory system 110, one or more memory devices 120, and/or one or more controllers (e.g., the memory system controller 115 and/or one or more local controllers 125).

As shown in FIG. 2A, and by reference number 215, the host system 205 may transmit, and the memory apparatus 210 may receive, a request for supported memory operations. For example, the host system 205 may communicate the request for supported memory operations of the memory apparatus 210 (e.g., via a host interface, such as the host interface 140). In some implementations, the host system 205 may communicate the request as part of an initial configuration of the memory apparatus 210. Additionally, or alternatively, the host system 205 may communicate the request at other times of operation of the memory apparatus 210 (e.g., periodically, as part of a reconfiguration procedure). In some implementations, the request may be a request for supported use cases associated with the memory apparatus 210 (e.g., a GetSupportedUseCases message). For example, “supported memory operations” may be used interchangeably with “supported use cases” herein.

A supported memory operation of the memory apparatus 210 may include a type of memory operation. As described herein, a supported memory operation may be an operation to access memory resources of the memory apparatus 210, such as a write operation (e.g., a program operation), a read operation, and/or an erase operation, among other examples. For example, supported memory operations of the memory apparatus 210 may include a sequential read operation, such as an operation to retrieve data from a sequential portion of the memory apparatus 210 (e.g., a sequential set of logical addresses of the memory apparatus 210, a sequential set of physical addresses of the memory apparatus 210). Additionally, or alternatively, supported memory operations of the memory apparatus may include a sequential write operation, such as an operation to store data to a sequential portion of the memory apparatus 210. Additionally, or alternatively, supported memory operations of the memory apparatus 210 may include a random read operation, such as on operation to retrieve data from non-sequential portions of the memory apparatus 210. Additionally, or alternatively, supported memory operations of the memory apparatus 210 may include a random write operation, such as an operation to store data having a non-sequential portions set of logical addresses.

In some implementations, the memory apparatus 210 may support multiple performance modes. For example, the memory apparatus 210 may support a mode that enables write-booster operations, in which the memory apparatus 210 performs write operations from the host system 205 by storing data from the host system 205 to SLCs, rather than storing the data to memory cells configured to store multiple bits of data, such as MLCs, TLCs, and/or QLCs, among other examples. Accordingly, the data transfer rate of write-booster operations may be different (e.g., higher) than the data transfer rate of non-write-booster operations (e.g., memory operations in which the memory apparatus 210 may store data to SLCs, MLCs, TLCs, and/or QLCs). In such implementations, supported memory operations may include write-booster operations (e.g., the supported memory operations may include a write booster operation and a non-write-booster operation).

As shown by reference number 220, the memory apparatus 210 may transmit, and the host system 205 may receive, capability information indicating memory operations supported by the memory apparatus 210. For example, based on, in response to, or otherwise associated with receiving the request from the host system 205, the memory apparatus 210 may generate the capability information, for example by determining the capability information and/or retrieving the information, such as by retrieving the capability information from hardware identification, controller firmware, interface protocols, or other configuration information. The memory apparatus 210 may communicate the capability information to the host system 205. The capability information may include one or more information elements, such as fields of a device descriptor associated with the memory apparatus 210, that indicate the memory operations supported by the memory apparatus 210.

As shown by reference number 225, the host system 205 may determine one or more performance limits for respective supported memory operations indicated by the capability information. For example, the host system 205 may determine values of one or more thresholds for one or more performance parameters corresponding to one or more of the supported memory operations. In some implementations, the host system 205 may determine one or more time windows (e.g., durations) associated with the one or more memory operations. As described herein, a time window may refer to an amount of time over which a performance limit is to be met for the performance of a memory operations. For example, a time window may indicate an amount of time over which to measure and/or average the performance of a memory operation for comparison to the performance limit. In such examples, the memory apparatus 210 may limit performance of a memory operation such that the performance satisfies (e.g., does not exceed) a threshold value for a supported memory operation over a time window. In some implementations, if the memory apparatus 210 supports both a write-booster mode and a non-write-booster mode, then the host system 205 may determine one or more performance limits for operations associated with the write-booster mode and/or one or more performance limits for operations associated with the non-write-booster mode. The host system 205 may determine and/or configure the one or more performance limit in accordance with one or more rules or regulations promulgated by one or more agencies or regulatory bodies. Additionally, or alternatively, the host system 205 may determine the performance limits to achieve improved uniformity of performance, as described in more detail elsewhere herein.

In some implementations, a performance limit may indicate a value of a threshold associated with a performance parameter. A performance parameter may be any parameter that is indicative of a performance level of the memory apparatus 210. A performance parameter may include a throughput parameter, a data transfer rate parameter, a latency parameter, a write speed parameter, a read speed parameter, a random access time parameter, and/or an input-output operations per second (IOPS) parameter, among other examples.

For example, a performance limit may indicate a value of a threshold associated with a throughput parameter for a given memory operation (e.g., a supported memory operation). As described herein, a throughput parameter for a memory operation may refer to a rate at which the memory apparatus 210 processes data associated with the memory operation. Additionally, or alternatively, a throughput parameter may refer to a total amount of data processed as part of performing a memory operation (e.g., over a time window associated with the memory operation). A value of a threshold associated with a throughput parameter may indicate a performance limit for the throughput parameter, such as a target rate for the throughput parameter (e.g., over the time window). For example, a throughput parameter for a sequential read operation may correspond to the rate at which the memory apparatus 210 retrieves data and transmits the data to the host system 205. To determine a performance limit associated with a sequential read operation, the host system 205 may determine a target rate for the throughput parameter, such as M megabytes (MB) per second. Additionally, or alternatively, the host system 205 may determine the performance limit by determining an amount of data and/or a time window for the memory operation, such as S MB over T seconds. Additionally, or alternatively, the host system 205 may determine a performance limit by determining a quantity of units (e.g., a quantity of data units, or a quantity of operations) associated with a memory operation and/or a time window associated with the memory operation. For example, a performance limit may indicate a quantity of IOPS. As described herein, an IOPS may indicate the quantity of operations (e.g., read operations and/or write operations) completed by the memory apparatus 210 within one (1) second.

In some implementations, a performance limit may indicate a value of a threshold associated with a latency parameter. As described herein, a latency parameter for a memory operation may refer to a duration (e.g., an amount of time) between the memory apparatus 210 receiving a command for the memory operation and the memory apparatus 210 processing (e.g., completing, executing, and/or performing) the memory operation. In such cases, a value of a threshold associated with the latency parameter may indicate a target latency for the latency parameter. For example, a latency parameter for a sequential read operation may correspond to a duration (e.g., an amount of time) between the memory apparatus 210 receiving a command for data associated with the sequential read operation and the memory apparatus 210 transmitting the data to the host system 205. To determine a performance limit associated with a sequential read operation, the host system 205 may determine a target latency for the latency parameter. In some implementations, the target latency for a memory operation may be based on the size of data associated with the memory operation. For example, the target latency for a random read operation to retrieve a first size of data (e.g., 4 kilobytes (kBs) of data, and/or a single page of data) may be less than the target latency for a random read operation to retrieve a second size of data greater than the first size (e.g., 256 kBs of data, and/or multiple pages of data). Accordingly, the host system 205 may determine multiple target latencies for a given memory operation (e.g., where the multiple target latencies correspond to respective sizes of data). As a result, by enabling the host system 205 to set a target latency for a memory operation, the host system 205 may improve the uniformity of performance of the memory apparatus 210. Further, by configuring the latency of the memory apparatus 210, the host system 205 may extend the lifespan of the memory apparatus 210, reduce a likelihood of component failure for the memory apparatus 210, and/or reduce the likelihood of overheating by the memory apparatus 210, among other examples. Additionally, by enabling the memory apparatus 210 to operate at a relatively higher latency, the memory apparatus 210 may conserve power or energy that would have otherwise been associated with the operation of the memory apparatus 210 at a latency that is less than a target latency.

In some implementations, the host system 205 may transmit, and the memory apparatus 210 may receive, one or more communications to modify a value of one or more of the performance limits. For example, as part of operating the memory apparatus 210, the host system 205 may determine to update or adjust a performance limit. In some cases, the host system 205 may modify the value of the one or more performance limits in response, based on, or otherwise associated with a user input and/or a measurement of the performance of the memory apparatus 210, among other examples. In such examples, the host system 205 may determine one or more updated performance limits for one or more supported memory operations. The host system 205 may communicate (e.g., transmit or provide) a message to the memory apparatus 210 to modify the performance limits to the updated performance limits. In some examples, the host system 205 may modify a value of the one or more performance limits during operation of the memory apparatus 210 (e.g., during runtime, subsequent to an initial configuration of the memory apparatus 210).

As shown in FIG. 2B, and by reference number 230, the host system 205 may transmit (e.g., provide), and the memory apparatus 210 may receive (e.g., obtain), configuration information indicating the one or more performance limits for the supported memory operations. For example, the host system 205 may communicate (e.g., transmit or provide via a host interface, such as the host interface 140) one or more commands that include the configuration information to the memory apparatus 210. In some implementations, each command of the one or more commands may be a command to set one or more parameters, such as a performance limit of the memory apparatus 210 and/or a time window associated with each memory operation (e.g., a SetUseCasePerformanceLimit message). In some implementations, each command of the one or more commands may include an information element, such as one or more fields of a descriptor block, indicating a supported memory operation (e.g., an indication of the type of memory operation associated with the command). Additionally, or alternatively, an information element may include an indication of a performance limit corresponding to the supported memory operation (e.g., a target rate for the supported memory operation, a target latency for the supported memory operation). Additionally, or alternatively, an information element may include an indication of time window corresponding to the performance limit. In such implementations, the host system 205 may communicate (e.g., transmit or provide) one or more commands to configure the performance limit for one or more of the supported memory operations.

As shown by reference number 235, the memory apparatus 210 may perform one or more memory operations in accordance with the one or more performance limits. For example, the memory apparatus 210 may adjust one or more performance parameters, such as by adjusting speeds corresponding to the memory operation and/or limiting (e.g., reducing, configuring) one or more values of one or more performance parameters associated with the memory operation, among other examples, to operate in accordance with the one or more performance limits. As another example, the memory apparatus 210 may adjust one or more parameters associated with a credit scheme used to manage memory operations, among other examples, to operate in accordance with the one or more performance limits.

As used herein, the memory apparatus 210 performing one or more memory operations in accordance with the one or more performance limits may refer to the memory apparatus 210 ensuring that one or more performance parameters associated with the one or more memory operations satisfy the one or more performance limits over the time window. As used herein, “satisfying” or “meeting” a performance limit may refer to a value (e.g., of a performance parameter) satisfying a threshold indicated by the performance limit. A performance limit may include a time window. The time window may be a duration over which the memory apparatus is to meet or satisfy the one or more performance limits. For example, to meet or satisfy a performance parameter, the memory apparatus 210 may limit values of one or more performance parameters, for one or more memory operations, to be less than or equal to corresponding thresholds indicated by the one or more performance limits.

For example, the memory apparatus 210 may determine performance parameters by tracking a quantity of data units associated with a memory operation, such as UFS protocol information units (UPIUs) transferred over a time window associated with the memory operation. If the performance parameter is at or near the performance limit (e.g., within a tolerance value of the performance limit), then the memory apparatus 210 may limit (e.g., throttle) performance of the memory operation to satisfy the performance limit. For example, the memory apparatus 210 may adjust (e.g., reduce or limit) the speed of a memory operation, such as by stalling or delaying one or more commands associated with the memory operations and/or adjusting a clock speed used by the memory apparatus 210 to perform a memory operation, among other examples. In some implementations, one or more performance parameters for a memory operation may temporarily exceed the associated performance limit (e.g., during a portion of the time window associated with the performance limit). In such examples, the memory apparatus 210 may further limit performance during other portions of the time window, such that the value of the performance parameter averaged over the time window satisfies the performance limit.

Additionally, or alternatively, the memory apparatus 210 may implement a credit-based scheme to operate in accordance with the configuration information. For example, the memory apparatus 210 may manage one or more counters (e.g., “credits”), for example by periodically adding a value to the one or more counters. As part of performing a memory operation, the memory apparatus 210 may determine whether a counter of the one or more counter satisfies a threshold. If the counter satisfies the threshold, the memory apparatus 210 may perform the memory operation.

Alternatively, if the counter does not satisfy the threshold, the memory apparatus 210 may refrain from performing the memory operation, such as by stalling or delaying the memory operation until the counter satisfies the threshold. After performing the memory operation, the memory apparatus 210 may decrement the associated counter by a pre-determined value corresponding to the memory operation.

In some implementations, the memory apparatus 210 may determine or adjust the threshold and/or values by which the counter may be decremented, such that the average performance parameter of the memory apparatus 210 for the memory operation may satisfy the performance limit associated with the memory operation. For example, if a sequential read operation is associated with a target data transfer rate of 4000 MB per second, then the memory apparatus 210 may adjust the threshold and/or values by which the counter may be decremented such that the throughput parameter associated with the sequential read operation is less than or equal to 4000 MB per second over the time window associated with the sequential read operation, even if the memory apparatus 210 may be capable of performing the sequential read operation at a higher data transfer rate. Additionally, or alternatively, if a sequential read operation is associated with a target latency of X seconds, then the memory apparatus 210 may adjust the threshold and/or values by which the counter may be decremented such that the latency parameter associated with the sequential read operation (e.g., the amount of time taken by the memory apparatus 210 to complete the sequential read operation) is greater than or equal to X seconds, even if the memory apparatus 210 may be capable of performing the sequential read operation with a lower latency. By limiting the performance of memory operations, the memory apparatus 210 may improve the uniformity of performance of the memory apparatus 210. Additionally, or alternatively, limiting the performance of memory operations may reduce power used by the memory apparatus 210 (e.g., by reducing the quantity and/or speed of memory operations), which may in turn extend the lifespan of the memory apparatus 210, reduce a likelihood of component failure for the memory device, and/or reduce the likelihood of overheating by the memory apparatus 210, among other examples.

As indicated above, FIGS. 2A and 2B are provided as examples. Other examples may differ from what is described with regard to FIGS. 2A and 2B.

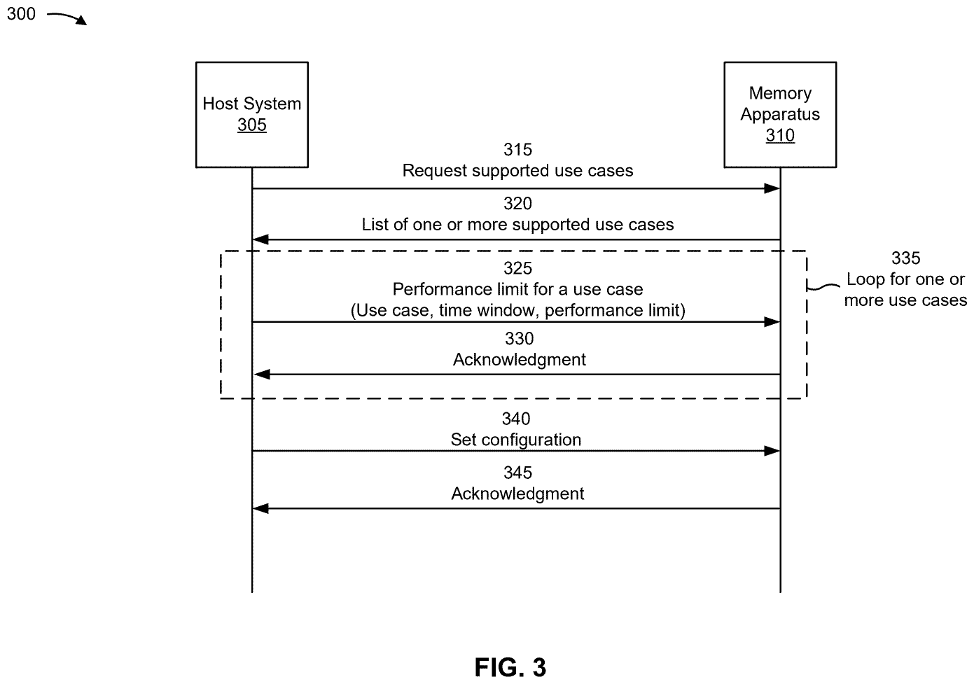

FIG. 3 is a diagram of an example 300 of host configured performance limits. The operations described in connection with FIG. 3 may be performed by the memory system 110 and/or one or more components of the memory system 110, such as the memory system controller 115, one or more memory devices 120, and/or one or more local controllers 125. Additionally, or alternatively, the operations described in connection with FIG. 3 may be performed by the system 100, the host system 105, one or more component of the host system 105 (e.g., the host processor 150), and/or the host interface 140.

As shown in FIG. 3, the example 300 may include a host system 305 and a memory apparatus 310. The host system 305 may be the host system 105 and/or the host system 205. The memory apparatus 310 may be, or may include, the memory apparatus 210, the memory system 110, one or more memory devices 120, and/or one or more controllers (e.g., the memory system controller 115 and/or one or more local controllers 125).

As shown by reference number 315, the host system 305 may transmit, and the memory apparatus 310 may receive, a request for supported use cases of the memory apparatus 310. For example, the host system 305 may provide, and the memory apparatus may obtain, a request for supported memory operations (e.g., via a host interface, such as the host interface 140). In some implementations, the host system 305 may communicate the request as part of an initial configuration of the memory apparatus 310. Additionally, or alternatively, the host system 305 may communicate the request at other times of operation of the memory apparatus 310 (e.g., periodically and/or as part of a reconfiguration procedure).

As shown by reference number 320, the memory apparatus 310 may transmit, and the host system 305 may receive, a list of one or more supported use cases of the memory apparatus 310. For example, the memory apparatus 310 may provide, and the host system 305 may obtain, capability information indicating memory operations supported by the memory apparatus 310. For example, based on, in response to, or otherwise associated with receiving the request from the host system 305, the memory apparatus 310 may generate the capability information. To generate the capability information, the host system 205 may determine the capability information and/or retrieve the information, such as by retrieving the capability information from hardware identification, controller firmware, interface protocols, or other configuration information. The memory apparatus 310 may communicate (e.g., transmit or provide) the capability information to the host system 305.

In some implementations, the host system 305 may determine one or more performance limits for respective supported memory operations indicated by the capability information. For example, the host system 305 may determine target rates (e.g., one or more target rates for one or more throughput parameters) and/or target latencies (e.g., one or more target latencies for one or more latency parameters) for the memory apparatus 310 to perform one or more of the supported memory operations, among other examples. In some implementations, such as if the memory apparatus 310 supports both a write-booster mode and a non-write-booster mode, the host system 305 may determine performance limits for operations associated with the write-booster mode and/or performance limits for operations associated with the non-write-booster mode. The host system 305 may determine the one or more performance limits to improve uniformity of performance of the memory apparatus 310. Additionally, by enabling the host system 305 to define performance limits, a diversity of types of memory apparatuses that may be included in the electronic device may be improved. For example, if the host system 305 supports a lower performance standard for the memory operations, then the host system 305 may use a higher performance memory apparatus 310 and may limit the performance of the memory apparatus 310 by configuring the one or more performance limits (e.g., causing the memory apparatus 310 to operate at a relatively lower performance). Further, by operating the memory apparatus 310 at a relatively lower performance, the host system 305 may extend the lifespan of the memory apparatus 310, reduce a likelihood of component failure for the memory apparatus 310, and/or reduce the likelihood of overheating by the memory apparatus 310, among other examples. Additionally, by enabling the memory apparatus 310 to operating at a relatively lower performance, the memory apparatus 310 may conserve power or energy that would have otherwise been associated with the operation of the memory apparatus 310 at a performance level that is greater than a configured performance limit.

As shown by reference number 325, the host system 305 may transmit, and the memory apparatus 310 may receive, configuration information indicating one or more performance limits for a given use case (e.g., for a given supported memory operation). For example, the host system 305 may communicate (e.g., transmit or provide via a host interface, such as the host interface 140) a command that includes the configuration information for a given memory operation to the memory apparatus 310. In some implementations, the command may include an information element, such as one or more fields of a descriptor block, indicating a supported memory operation (e.g., an indication of the type of memory operation or a use case associated with the command). In some implementations, the capability information and/or the configuration information may be communicated as part of an initialization (e.g., an initial configuration) of the memory apparatus 310. For example, an initialization of the memory apparatus 310 may include operations to prepare the memory apparatus 310 for operation. In some embodiments, the host system 305 and/or the memory apparatus 310 may perform such operations based on, in response to, or otherwise associated with a power-on condition of the host system 305 and/or the memory apparatus 310. For example, as part of an operation to set an initial configuration (e.g., define or otherwise determine initial parameters) of the memory apparatus 310, the host system 305 and the memory apparatus 310 may communicate the capability information and/or the configuration information.

Additionally, or alternatively, the information element may include an indication of a performance limit corresponding to the supported memory operation, such as a target rate for the memory operation (e.g., in units of MBs per second, or IOPS). Additionally, or alternatively, the performance limit may correspond to a target size of data (e.g., in units of MBs). Additionally, or alternatively, the performance limit may correspond to a target latency (e.g., and the performance limit may indicate a value in units of time). In some implementations, the information element may include an indication of a time window associated with the performance limit. For example, the time window may indicate an amount (e.g., a length) of time over which the memory apparatus 310 may ensure that a value of a throughput parameter (e.g., a data transfer rate) satisfies a threshold corresponding to the performance limit. In some examples, such as if the performance limit indicates a target size of data, the time window may indicate an amount of time over which the memory apparatus 310 may ensure that the total amount of data associated with the memory operation satisfies 310 a threshold corresponding to the performance limit.

As shown by reference number 330, after receiving the configuration information, the memory apparatus 310 may transmit, and the host system 305 may receive, an acknowledgment message. By receiving the acknowledgement, the host system 305 may verify that the configuration information has been received. In some implementations, as shown by reference number 335, the host system 305 and the memory apparatus 310 may repeat (e.g., “loop”) the operations depicted and/or described in connection with reference number 325 and/or reference number 330. For example, the host system 305 may transmit, and the memory apparatus 310 may receive, configuration information indicating a performance limit for one or more supported memory operations. For example, the host system 305 may provide, and the memory apparatus 310 may obtain, information elements indicating respective performance limits for one or more use cases for which the host system 305 has determined to set a performance limit. In such examples, the memory apparatus 310 may transmit, and the host system 305 may receive, an acknowledgement message for the received configuration information (e.g., an acknowledgment message for each information element received by the memory apparatus 310). By operating a memory apparatus 310 at a relatively lower performance, the host system 305 may extend the lifespan of a memory apparatus 310, reduce a likelihood of component failure for the memory apparatus 310, and/or reduce the likelihood of overheating by the memory apparatus 310, among other examples. This may reduce electronic waste and improve reliability of the memory apparatus. Additionally, by enabling the memory apparatus 310 to operate at a relatively lower performance, the memory apparatus 310 may conserve power or energy that would have otherwise been associated with the operation of the memory apparatus 310 at a performance level that is greater than a configured performance limit.

In some implementations, as shown by reference number 340, the host system 305 may transmit, and the memory apparatus 310 may receive, a command to set the configuration of the memory apparatus 310. For example, the host system 305 may communicate a command to “lock” the configuration of the memory apparatus 310 (e.g., a SetDescriptorLock (locked) command), such that the configuration information indicated by the host system 305 as described in connection with reference numbers 325 may not subsequently be modified. In such cases, as shown by reference number 345, the memory apparatus 310 may transmit, and the host system 305 may receive, an acknowledgment to the command. Alternatively, the example 300 may omit communicating the command to set the configuration and the associated acknowledgement. For example, the configuration information of the memory apparatus 310 may subsequently be updated and/or modified, such as by the host system 305 or by another electronic device. For example, the host system 305 may transmit one or more messages to the memory apparatus 310 to update, modify, add, and/or remove one or more performance limits during runtime of the memory apparatus 310, in a similar manner as described in more detail elsewhere herein.

As indicated above, FIG. 3 is provided as an example. Other examples may differ from what is described with regard to FIG. 3.

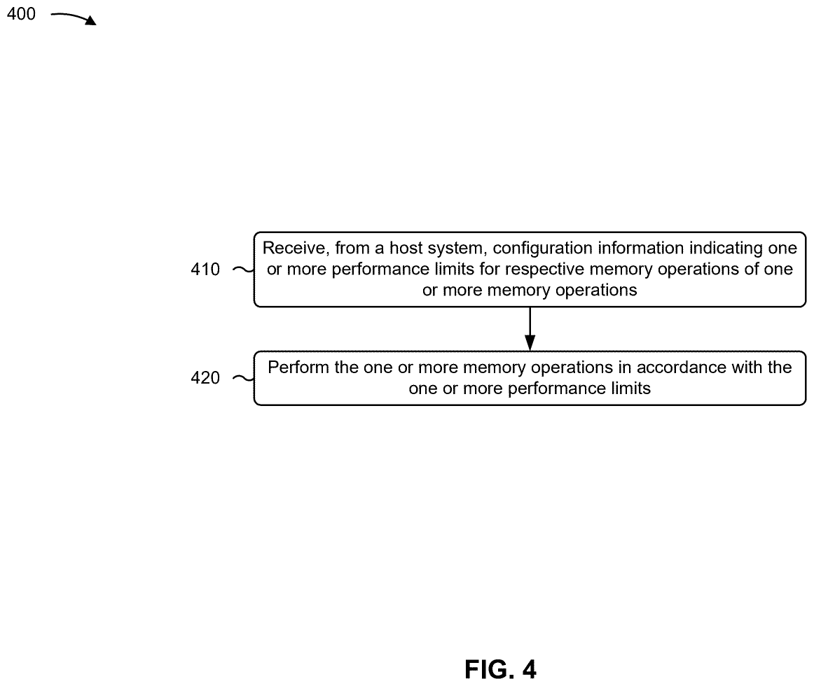

FIG. 4 is a flowchart of an example method 400 associated with host configured performance limits. In some implementations, a memory apparatus (e.g., the memory system 110, a memory device 120, the memory apparatus 210, and/or the memory apparatus 310) may perform or may be configured to perform the method 400. In some implementations, another device or a group of devices separate from or including the memory apparatus (e.g., the host system 105, the host processor 150, the host system 205, and/or the host system 305) may perform or may be configured to perform the method 400. Additionally, or alternatively, one or more components of the memory apparatus (e.g., the memory system controller 115, one or more memory arrays 130, one or more volatile memory arrays 135, the memory devices 120, and/or the local controllers 125) may perform or may be configured to perform the method 400. Thus, means for performing the method 400 may include the memory apparatus and/or one or more components of the memory apparatus. Additionally, or alternatively, a non-transitory computer-readable medium may store one or more instructions that, when executed by the memory apparatus, cause the memory apparatus to perform the method 400.

As shown in FIG. 4, the method 400 may include receiving, from a host system, configuration information indicating one or more performance limits for respective memory operations of one or more memory operations (block 410). As further shown in FIG. 4, the method 400 may include performing the one or more memory operations in accordance with the one or more performance limits (block 420).

The method 400 may include additional aspects, such as any single aspect or any combination of aspects described below and/or described in connection with one or more other methods or operations described elsewhere herein.

In a first aspect, the method 400 includes limiting values of the one or more performance parameters, for the one or more memory operations, to be less than or equal to corresponding thresholds of the one or more thresholds.

In a second aspect, alone or in combination with the first aspect, the one or more performance parameters include at least one of a throughput parameter, or a latency parameter.

In a third aspect, alone or in combination with one or more of the first and second aspects, the one or more performance limits include one or more data transfer rate limits for the one or more memory operations.

In a fourth aspect, alone or in combination with one or more of the first through third aspects, the method 400 includes adjusting one or more speeds of the one or more memory operations to meet the data transfer rate limit.

In a fifth aspect, alone or in combination with one or more of the first through fourth aspects, the one or more performance limits are associated with a time window, and one or more performance parameters associated with the one or more memory operations satisfy the one or more performance limits over the time window.

In a sixth aspect, alone or in combination with one or more of the first through fifth aspects, the one or more performance limits include different performance limits for different memory operations of the one or more memory operations.

In a seventh aspect, alone or in combination with one or more of the first through sixth aspects, the method 400 includes receiving an information element for a performance limit of the one or more performance limits, where the information element indicates a memory operation, of the one or more memory operations, associated with the performance limit, a value of the performance limit, and a time window over which the value is to be met for performance of the one or more memory operations.

In an eighth aspect, alone or in combination with one or more of the first through seventh aspects, the one or more memory operations are supported use cases for the memory apparatus.

In a ninth aspect, alone or in combination with one or more of the first through eighth aspects, the one or more memory operations include at least one of a sequential read operation, a sequential write operation, a random read operation, or a random write operation.

In a tenth aspect, alone or in combination with one or more of the first through ninth aspects, the one or more memory operations include at least one of a write-booster operation, or a non-write-booster operation.

Although FIG. 4 shows example blocks of a method 400, in some implementations, the method 400 may include additional blocks, fewer blocks, different blocks, or differently arranged blocks than those depicted in FIG. 4. Additionally, or alternatively, two or more of the blocks of the method 400 may be performed in parallel. The method 400 is an example of one method that may be performed by one or more devices described herein. These one or more devices may perform or may be configured to perform one or more other methods based on operations described herein.

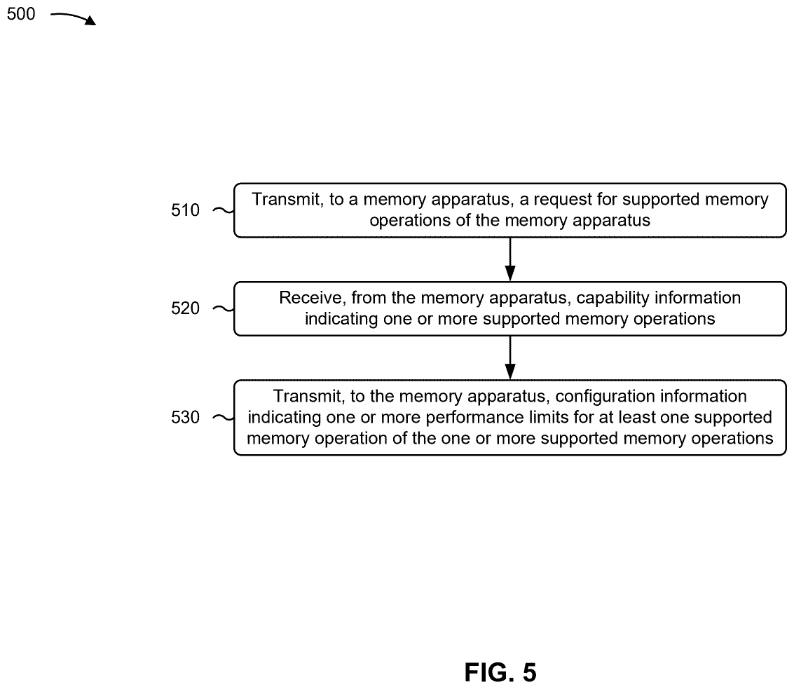

FIG. 5 is a flowchart of an example method 500 associated with host configured performance limits. In some implementations, a host system (e.g., the host system 105, the host system 205, and/or the host system 305) may perform or may be configured to perform the method 500. In some implementations, another device or a group of devices separate from or including the host system (e.g., the memory system 110, one or more memory devices 120, the memory apparatus 210, and/or the memory apparatus 310) may perform or may be configured to perform the method 500. Additionally, or alternatively, one or more components of the host system (e.g., the host processor 150) may perform or may be configured to perform the method 500. Thus, means for performing the method 500 may include the host system and/or one or more components of the host system. Additionally, or alternatively, a non-transitory computer-readable medium may store one or more instructions that, when executed by the host system, cause the host system to perform the method 500.

As shown in FIG. 5, the method 500 may include transmitting, to a memory apparatus, a request for supported memory operations of the memory apparatus (block 510). As further shown in FIG. 5, the method 500 may include receiving, from the memory apparatus, capability information indicating one or more supported memory operations (block 520). As further shown in FIG. 5, the method 500 may include transmitting, to the memory apparatus, configuration information indicating one or more performance limits for at least one supported memory operation of the one or more supported memory operations (block 530).

The method 500 may include additional aspects, such as any single aspect or any combination of aspects described below and/or described in connection with one or more other methods or operations described elsewhere herein.

In a first aspect, configuration information indicates performance limits, of the one or more performance limits, for respective supported memory operations of the one or more supported memory operations.

In a second aspect, alone or in combination with the first aspect, a performance limit, of the one or more performance limits, indicates a threshold value for a performance parameter that is not be exceeded over a time window during a performance of a supported memory operation of the one or more supported memory operations.

In a third aspect, alone or in combination with one or more of the first and second aspects, the one or more performance limits include an input-output operations per second (IOPS) limit.

In a fourth aspect, alone or in combination with one or more of the first through third aspects, the method 500 includes transmitting, to the memory apparatus, a communication modifying a value of at least one performance limit of the one or more performance limits.

In a fifth aspect, alone or in combination with one or more of the first through fourth aspects, the one or more supported memory operations include at least one of one or more write operations, or one or more read operations.

Although FIG. 5 shows example blocks of a method 500, in some implementations, the method 500 may include additional blocks, fewer blocks, different blocks, or differently arranged blocks than those depicted in FIG. 5. Additionally, or alternatively, two or more of the blocks of the method 500 may be performed in parallel. The method 500 is an example of one method that may be performed by one or more devices described herein. These one or more devices may perform or may be configured to perform one or more other methods based on operations described herein.

In some implementations, a memory apparatus includes one or more controllers configured to: receive, from a host system, configuration information indicating one or more performance limits for respective memory operations of one or more memory operations; and perform the one or more memory operations in accordance with the one or more performance limits.

In some implementations, a host system includes one or more controllers configured to: transmit, to a memory apparatus, a request for supported memory operations of the memory apparatus; receive, from the memory apparatus, capability information indicating one or more supported memory operations; and transmit, to the memory apparatus, configuration information indicating one or more performance limits for at least one supported memory operation of the one or more supported memory operations.

In some implementations, a method includes transmitting, by a memory apparatus and to a host system, capability information indicating one or more supported memory operations of the memory apparatus; and receiving, by the memory apparatus and from the host system, configuration information indicating one or more performance limits for at least one supported memory operation of the one or more supported memory operations.

In some implementations, a system includes a host system; a memory apparatus; a host interface between the host system and the memory apparatus; and one or more controllers configured to: communicate, via the host interface and to the host system, capability information of the memory apparatus indicating one or more supported memory operations of the memory apparatus; and communicate, via the host interface and to the memory apparatus, configuration information indicating one or more performance limits for at least one supported memory operation of the one or more supported memory operations.

The foregoing disclosure provides illustration and description but is not intended to be exhaustive or to limit the implementations to the precise forms disclosed. Modifications and variations may be made in light of the above disclosure or may be acquired from practice of the implementations described herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A memory apparatus, comprising:
one or more controllers configured to:
receive, from a host system, configuration information indicating one or more performance limits for respective memory operations of one or more memory operations; and
perform the one or more memory operations in accordance with the one or more performance limits.

2. The memory apparatus of claim 1, wherein the one or more performance limits indicate values of respective thresholds from one or more thresholds, wherein the one or more thresholds are associated with respective performance parameters from one or more performance parameters, and wherein the one or more controllers, to perform the one or more memory operations, are configured to:
limit values of the one or more performance parameters, for the one or more memory operations, to be less than or equal to corresponding thresholds of the one or more thresholds.

3. The memory apparatus of claim 2, wherein the one or more performance parameters include at least one of:
a throughput parameter, or
a latency parameter.

4. The memory apparatus of claim 1, wherein the one or more performance limits include one or more data transfer rate limits for the one or more memory operations.

5. The memory apparatus of claim 4, wherein the one or more controllers, to perform the one or more memory operations, are configured to:
adjust one or more speeds of the one or more memory operations to meet the data transfer rate limit.

6. The memory apparatus of claim 1, wherein the one or more performance limits are associated with a time window, and
wherein one or more performance parameters associated with the one or more memory operations satisfy the one or more performance limits over the time window.

7. The memory apparatus of claim 1, wherein the one or more performance limits include different performance limits for different memory operations of the one or more memory operations.

8. The memory apparatus of claim 1, wherein the one or more controllers, to receive the configuration information, are configured to:
receive an information element for a performance limit of the one or more performance limits, wherein the information element indicates:
a memory operation, of the one or more memory operations, associated with the performance limit,
a value of the performance limit, and
a time window over which the value is to be met for performance of the one or more memory operations.

9. The memory apparatus of claim 1, wherein the one or more memory operations are supported use cases for the memory apparatus.

10. The memory apparatus of claim 1, wherein the one or more memory operations include at least one of:
a sequential read operation,
a sequential write operation,
a random read operation, or
a random write operation.

11. The memory apparatus of claim 1, wherein the one or more memory operations include at least one of:
a write-booster operation, or
a non-write-booster operation.

12. A host system, comprising:
one or more controllers configured to:
transmit, to a memory apparatus, a request for supported memory operations of the memory apparatus;
receive, from the memory apparatus, capability information indicating one or more supported memory operations; and
transmit, to the memory apparatus, configuration information indicating one or more performance limits for at least one supported memory operation of the one or more supported memory operations.

13. The host system of claim 12, wherein configuration information indicates performance limits, of the one or more performance limits, for respective supported memory operations of the one or more supported memory operations.

14. The host system of claim 12, wherein a performance limit, of the one or more performance limits, indicates a threshold value for a performance parameter that is not be exceeded over a time window during a performance of a supported memory operation of the one or more supported memory operations.

15. The host system of claim 12, wherein the one or more performance limits include an input-output operations per second (IOPS) limit.

16. The host system of claim 12, wherein the one or more controllers are further configured to:
transmit, to the memory apparatus, a communication modifying a value of at least one performance limit of the one or more performance limits.

17. The host system of claim 12, wherein the one or more supported memory operations include at least one of:
one or more write operations, or
one or more read operations.

18. A method, comprising:
transmitting, by a memory apparatus and to a host system, capability information indicating one or more supported memory operations of the memory apparatus; and
receiving, by the memory apparatus and from the host system, configuration information indicating one or more performance limits for at least one supported memory operation of the one or more supported memory operations.

19. The method of claim 18, further comprising:
performing an operation for the at least one supported memory operation in accordance with the one or more performance limits.

20. The method of claim 19, wherein performing the operation comprises:
adjusting the operation to cause one or more performance parameters for the operation to not exceed the one or more performance limits.

21. The method of claim 18, wherein the configuration information indicates time windows for respective performance limits of the one or more performance limits,
wherein the time windows indicate durations over which the memory apparatus is to meet the one or more performance limits.

22. A system, comprising:
a host system;
a memory apparatus;
a host interface between the host system and the memory apparatus; and
one or more controllers configured to:
communicate, via the host interface and to the host system, capability information of the memory apparatus indicating one or more supported memory operations of the memory apparatus; and
communicate, via the host interface and to the memory apparatus, configuration information indicating one or more performance limits for at least one supported memory operation of the one or more supported memory operations.

23. The system of claim 22, wherein the one or more performance limits indicate latency parameters for respective operation sizes of the at least one supported memory operation.

24. The system of claim 22, wherein the one or more controllers are further configured to:
perform, by the memory apparatus, an operation for the at least one supported memory operation in accordance with the one or more performance limits.

25. The system of claim 22, wherein the capability information and the configuration information are communicated as part of an initialization of the memory apparatus.
